(19) United States
(12) Patent Application Publication
(10) Pub. No.: US 2022/0232131 A1
(43) Pub. Date: Jul. 21, 2022

(54) INFORMATION PROCESSING DEVICE AND INFORMATION PROCESSING METHOD

(71) Applicant: SHARP KABUSHIKI KAISHA, Osaka (JP)

(72) Inventor: Yuki SHIBAYAMA, Osaka (JP)

(21) Appl. No.: 17/563,761

(22) Filed: Dec. 28, 2021

(30) Foreign Application Priority Data
Jan. 21, 2021 (JP) 2021-008080

(51) Int. Cl. H04N 1/00; H04N 1/32; H04N 1/44

(52) U.S. Cl. CPC H04N 1/0097; H04N 1/32122; H04N 1/00408; H04N 2201/3204; H04N 2201/0094; H04N 2201/3202; H04N 1/44

(57) ABSTRACT

An information processing device includes: a controller that executes a job; and a storage that stores, as setting history information, a setting value related to the execution of the job, and the controller executes, after the execution of the job, determination processing on the setting value and reflects the result of determination to store the setting history information.

### BACKGROUND OF THE INVENTION

### Field of the Invention

The present invention relates to information processing devices and the like.

### Description of the Background Art

For example, an information processing device such as a multifunctional machine either reads, from an auxiliary storage device, setting values corresponding to various types of jobs such as data communication, copying, scanning and data storage or acquires the setting values from outside, and thereby executes the jobs. The setting values which are read or acquired are deployed to the working area of a main storage device and are used in processing executed with a computation device.

The setting values after the execution of the jobs are stored as setting history information in the auxiliary storage device. In recent years, an attempt has been made to utilize the setting history information described above to reduce time, work or steps related to the execution of a job and to thereby increase the efficiency of the execution of the job.

For example, in a job related to the data communication of fax, electronic mail or the like, setting values such as destinations and results of transmission in the data communication are acquired from setting history information related to executed jobs, and the setting values are chronologically arranged and displayed, with the result that it is possible to provide transmission history information of data to a user. The user sees the transmission history information to be able to grasp the destinations and the results of transmission in the data communication.

Incidentally, when the job related to the data communication is executed, it is necessary to select the destination of data. Information on the destination (hereinafter referred to as destination information) can be acquired, for example, from an address book managed by the main body of a device, by directly inputting the destination through a predetermined inputter such as a touch panel or from an address book managed by a portable terminal device such as a portable phone or a smart phone.

The address book managed by the main body of the device is originally stored in the main body of the device. Hence, the user does not feel much resistance to the fact that not only the destination information but also information on the result of transmission (hereinafter referred to as transmission result information) and the like are left in the main body of the device.

On the other hand, when the direct input of the destination through the inputter or the address book managed by the portable terminal device is utilized, the utilization thereof is often transient. Hence, the user may feel resistance to the fact that the destination information, the transmission result information and the like are left in the main body of the device.

Conditions in which the destination information and the transmission result information are easily exposed to others are not preferable in terms of privacy and security.

For example, Japanese Unexamined Patent Application Publication No. 2010-273030 discloses a data communication device which is shared by a large number of users and in which in order to prevent the information of history of communication of a registered user from being read by other users, the history of communication where part of important information or information desired to be kept secret is converted into unreadable information is displayed.

In the technique of Japanese Unexamined Patent Application Publication No. 2010-273030, it is possible to take measures against information leakage of the history of communication of users. However, measures with consideration given to privacy and security for whether or not to leave destination information or transmission result information according to from which one of an address book managed by the main body of the device, the direct input of a destination through an inputter and an address book managed by a portable terminal device the destination information is input are not virtually taken.

An object of the present disclosure is to provide an information processing device and the like which reflect processing corresponding to the acquisition source of setting values related to the execution of a job on setting history information to be able to ensure privacy and enhance security.

### SUMMARY OF THE INVENTION

In order to solve the problem described above, an information processing device according to the present disclosure includes: a controller that executes a job; and a storage that stores, as setting history information, a setting value related to the execution of the job, and the controller executes, after the execution of the job, determination processing on the setting value and reflects a result of determination to store the setting history information.

An information processing method according to the present disclosure includes: executing a job; and storing, as setting history information, a setting value related to the execution of the job and the execution of the job includes executing, after the execution of the job, determination processing on the setting value and reflecting a result of determination to store the setting history information.

According to the present disclosure, based on the acquisition sources of destination information such as an address book managed by the main body of a device, the direct input of a destination through an inputter and an address book managed by a portable terminal device, the handling of the destination information or transmission result information can be set. In an information processing device according to the present disclosure, it is possible to ensure privacy and enhance security without necessity to consider the leakage of destination information or transmission result information and the like.

### BRIEF DESCRIPTION OF THE DRAWINGS

FIG. 1 is an external view of a multifunctional machine according to a first embodiment.

FIG. 2 is a functional configuration view of the multifunctional machine according to the first embodiment.

FIG. 3 is a table for illustrating setting history information.

FIG. 4 is a flowchart for illustrating the flow of processing in the first embodiment.

FIG. 5 is a diagram for illustrating an example of an operation in the first embodiment.

FIG. 6 is a diagram for illustrating the example of the operation in the first embodiment.

FIG. 7 is a diagram for illustrating the example of the operation in the first embodiment.

FIG. 8 is a diagram for illustrating the example of the operation in the first embodiment.

FIG. 9 is a diagram for illustrating the example of the operation in the first embodiment.

FIG. 10 is a diagram for illustrating the example of the operation in the first embodiment.

FIGS. 11A, 11B and 11C are diagrams for illustrating the example of the operation in the first embodiment.

FIG. 12 is a flowchart for illustrating the flow of processing in a second embodiment.

FIG. 13 is a diagram for illustrating an example of an operation in the second embodiment.

FIGS. 14A, 14B and 14C are diagrams for illustrating the example of the operation in the second embodiment.

FIG. 15 is a flowchart for illustrating the flow of processing in a third embodiment.

FIG. 16 is a diagram for illustrating an example of an operation in the third embodiment.

### DESCRIPTION OF THE PREFERRED EMBODIMENTS

Embodiments of the present disclosure will be described below with reference to drawings. In the description of the embodiments, as an example of an information processing device, a multifunctional machine will be described which has the functions of data communication, copying, scanning, data storage and the like to execute jobs based on the functions. The following embodiments are examples for illustrating the present disclosure, and the technical scope of a description in the scope of claims is not limited to the following description.

### 1. First Embodiment

A multifunctional machine according to a first embodiment is the form of a multifunctional machine in which, for a destination derived from a specific address book management source, whether or not destination information or transmission result information is left can be selected. In the present specification, “leaving” the destination information or the transmission result information is used to have the same meaning as storing the information described above as setting history information in a setting device.

1.1 Functional Configuration

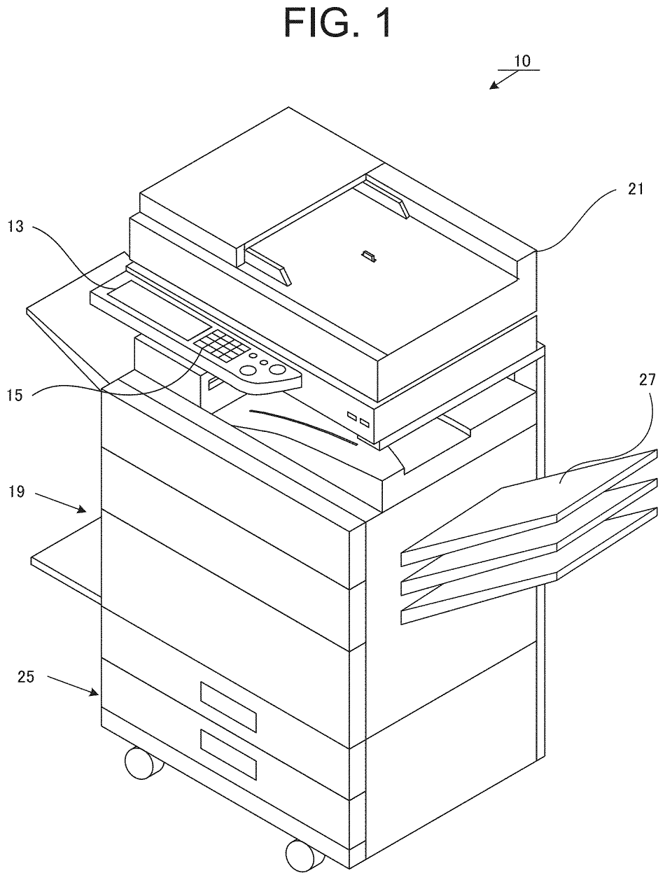

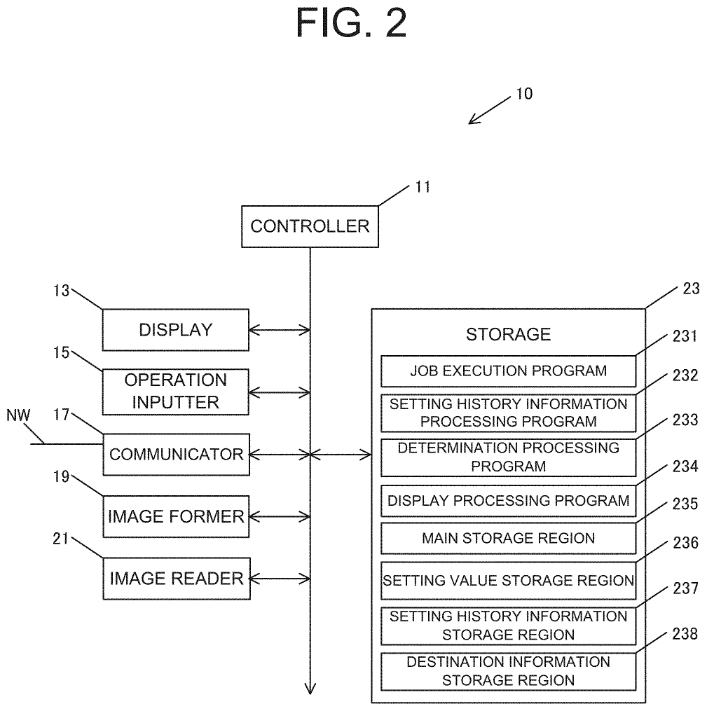

The functional configuration of the multifunctional machine 10 according to the first embodiment will be described with reference to FIGS. 1 and 2. FIG. 1 is an external view for illustrating the overall configuration of the multifunctional machine 10. FIG. 2 is a functional configuration view of the multifunctional machine 10.

The multifunctional machine 10 performs transmission and reception of fax through a commercially available telephone line, a facsimile communication network or the like, and has a data communication function of transmitting and receiving various types of data through electronic mail or the like. The multifunctional machine 10 has a copying function of forming, on a sheet serving as a recording medium, an image based on scan data generated by reading an original document and a print function of forming an image on the sheet based on image signals received through a network or the like or image data stored in a portable storage medium or the like. Furthermore, the multifunctional machine 10 has a data temporary storage function of temporarily storing various types of data such as image data and fax data in a storage device or a storage medium.

As shown in FIGS. 1 and 2, the multifunctional machine 10 includes a controller 11, a display 13, an operation inputter 15, a communicator 17, an image former 19, an image reader 21, a storage 23, a paper feeder 25 and a paper ejector 27.

The controller 11 controls the entire multifunctional machine 10. The controller 11 is formed with, for example, one or a plurality of computation devices (such as a CPU (Central processing unit)). The controller 11 reads and executes a job execution program 231, a setting history information processing program 232, a determination processing program 233, a display processing program 234 and the like stored in the storage 23 so as to realize the functions thereof.

The display 13 displays various types of information for a user or the like. The display 13 can be formed with, for example, an LCD (Liquid crystal display), an organic EL (Electro-luminescence) display or the like.

The operation inputter 15 receives the manual input of information such as setting values made by the user or the like. The operation inputter 15 can be formed with hard keys (for example, a numeric keypad), buttons and the like. The operation inputter 15 can also be formed as a touch panel which can make an input through the display 13. In this case, as an input detection method in the touch panel, a method such as a resistive film method, an infrared method, an electromagnetic induction method or a capacitance method can be adopted.

The communicator 17 is connected to another device through a network (NW) such as a LAN (Local area network), a WAN (Wide area network), the Internet, a commercially available telephone line or a facsimile communication network so as to transmit and receive various types of information such as image data and fax data, electronic mail and the like. The communicator 17 is formed, for example, as an interface capable of performing communication, and as a connection method, either or both of wired connection and wireless connection can be adopted.

The image former 19 forms, on the sheet, an image based on image data. The image former 19 feeds the sheet from the paper feeder 25, forms the image based on the image data on the sheet and then ejects the sheet to the paper ejector 27. The image former 19 can be formed with, for example, a laser printer or the like which utilizes an electrophotographic method. The image former 19 performs image formation using toners supplied from unillustrated toner cartridges which correspond to toner colors (for example, yellow (Y), magenta (M), cyan (C) and black (K)).

The image reader 21 generates the scan data by reading an image to be read. The image reader 21 can be formed with a scanner device or the like which uses an image sensor such as a CCD (Charge coupled device) or a CIS (Contact image sensor) to convert the image into electrical signals, which quantizes and encodes the image signals and which thereby generates digital data.

The paper feeder 25 includes trays in which a plurality of sheets stacked are stored. In the trays, sheets which have various sizes and thicknesses according to applications can be stored. The paper feeder 25 can be formed with, for example, a plurality of trays which respectively store the sheets of different sizes such as A4 size, B5 size and A3 size.

The paper ejector 27 includes plate-shaped stackers on which sheets ejected to the outside of the device after the image formation are stacked. As shown in FIG. 1, a plurality of stackers may be provided at a plurality of places to be able to eject sheets of different sizes.

The storage 23 stores various types of programs necessary for the operations of the multifunctional machine 10 and various types of data. The storage 23 can be formed with, for example, a volatile memory serving as a main storage device such as a RAM (Random access memory) and a nonvolatile memory serving as an auxiliary storage device such as a semiconductor memory of an SSD (Solid state drive), an HDD (Hard disk drive) or a ROM (Read only memory).

In the first embodiment, the storage 23 stores the job execution program 231, the setting history information processing program 232, the determination processing program 233 and the display processing program 234, and provides a main storage region 235, a setting value storage region 236, a setting history information storage region 237 and a destination information storage region 238.

The job execution program 231 is a program which is read by the controller 11 in order to execute, for each of the jobs, processing involving the execution of the data communication function, the print function, a fax function, a scan function or the like. The controller 11 reads the job execution program 231 to control individual portions involving the execution of the job.

The setting history information processing program 232 is a program which is read by the controller 11, for example, when the acquisition of setting values and the like related to the execution of a job, the generation of setting history information and various types of processing on the setting history information are executed. The controller 11 reads the setting history information processing program 232 to acquire the setting values related to the execution of a job and store them in the setting value storage region 236. The controller 11 uses the acquired setting values to generate the setting history information and stores it in the setting history information storage region 237.

The determination processing program 233 is a program which is read by the controller 11 when in a data communication job, whether or not the destination information is left, that is, whether or not the destination information is stored as the setting history information is determined. The controller 11 determines whether or not the destination information is stored as the setting history information according to from which one of an address book managed by the main body of the device, the direct input of a destination through the inputter and an address book managed by a portable terminal device the destination information is acquired. The controller 11 also determines whether or not in addition to the destination information, the transmission result information is stored as the setting history information. The storage of the destination information or the transmission result information as the setting history information can be set through a setting screen or a system setting. The controller 11 determines, based on the details of the setting, the storage of the destination information or the transmission result information in the storage 23 or the discard of the destination information or the transmission result information.

The display processing program 234 is a program which is read by the controller 11 when the destination information stored in the destination information storage region 238 is read and an address book screen is displayed for the user. The display processing program 234 is also a program which is read by the controller 11 when processing for displaying a transmission history or the like is executed. The controller 11 reads the display processing program 234 and controls the display 13 to be able to execute the processing for displaying the transmission history or the like.

The main storage region 235 is a storage region in which the destination information such as a destination number, a destination name and the like selected or input by the user and the setting values related to the execution of a job acquired from the setting value storage region 236 are temporarily stored. The controller 11 uses the main storage region 235 as a working area to execute the job based on the temporarily stored setting values.

The setting value storage region 236 is a storage region in which various setting values related to the execution of jobs are stored. The setting values include setting values set by the user in the execution of each job, device initial values held by the device itself and the like.

The setting values may be values which are directly input by the user through a touch panel or the like displayed on the operation inputter 15 or the display 13. When the multifunctional machine 10 is connected to an unillustrated external terminal device or the like through the communicator 17, the controller 11 can acquire setting values input through a control program such as a printer driver introduced by the external terminal device. The controller 11 stores the acquired setting values in the setting value storage region 236.

The setting history information storage region 237 is a storage region in which the setting history information is stored in a data table format. The setting history information in the first embodiment can be formed as history information in which a job ID for uniquely identifying information made by a combination of part or all of the setting values temporarily stored in the main storage region 235 and the setting values stored in the setting value storage region 236 and history information related to the execution of a job such as a job function, an execution user name and start date and time/completion date and time is provided.

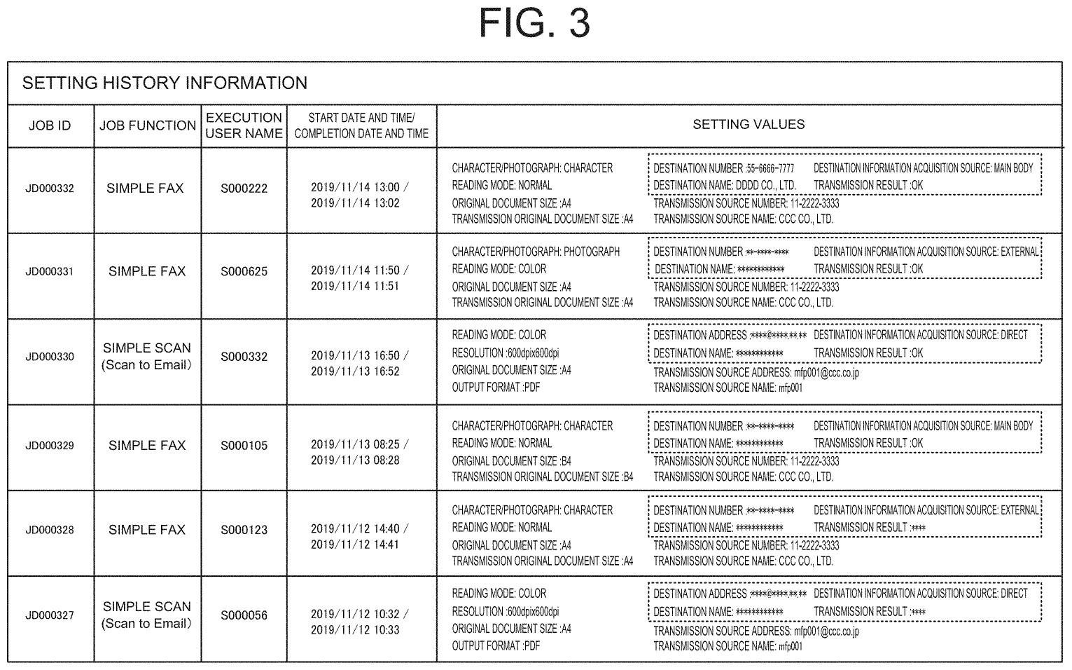

FIG. 3 is a diagram for illustrating an example of the configuration of the setting history information. For example, a job ID: JD000332 indicates the setting history information of the execution user of a user name: S000222 related to simple fax. The job described above was executed by the execution user S000222 at 13:00 on Nov. 14, 2019 and was completed at 13:02 on the same day. Setting values (items) included in the setting history information are not particularly limited as long as they are setting values stored in the setting value storage region 236. The setting values shown in FIG. 3 are simply illustrated, and the setting values in the present disclosure are not limited to details shown in FIG. 3.

The setting values in the setting history information indicated by the job ID: JD000332 include, as setting values, destination information such as a destination number (55-6666-7777) and a destination name (dddd Co., Ltd.), destination information acquisition source information (acquisition source: main body) and transmission result information (result of transmission: OK). These pieces of information are setting value stored in the setting history information when as a result of determination processing executed by the controller 11, it is determined that the destination information and the transmission result information are left in the setting history information.

Here, the setting history information indicated by the job ID: JD000332 indicates an example of the result of processing when the controller 11 determines that both the destination information and the transmission result information are left. When the controller 11 determines that both the destination information and the transmission result information are left, the destination information such as the destination number (55-6666-7777) and the destination name (dddd Co., Ltd.) and the transmission result information (result of transmission: OK) are stored as the setting history information.

Setting history information related to job IDs: JD000331 to JD000329 indicates examples of the result of processing when the controller 11 determines that the destination information is not stored and that only the transmission result information is left. In this case, the destination information is not stored, and the transmission result information (transmission: OK) is stored in the setting history information. Setting history information related to job IDs: JD000328 and JD000327 indicates examples of the result of processing when the controller 11 determines that both the destination information and the transmission result information are not left. In this case, both the destination information and the transmission result information are not stored as the setting history information (in FIG. 3, within dotted frames).

The destination information storage region 238 is a storage region in which the destination information of fax and electronic mail is stored. The destination information storage region 238 stores the destination information as the address book managed by the main body of the device. The destination information storage region 238 stores the address book acquired from the portable terminal device, the destination information directly input through the inputter and the like. The destination information stored in the destination information storage region 238 is read when the data communication of fax, electronic mail or the like is executed, and is displayed as the address book screen. The user selects a desired destination through the address book screen displayed to be able to select the destination of the data communication.

1.2 Flow of Processes

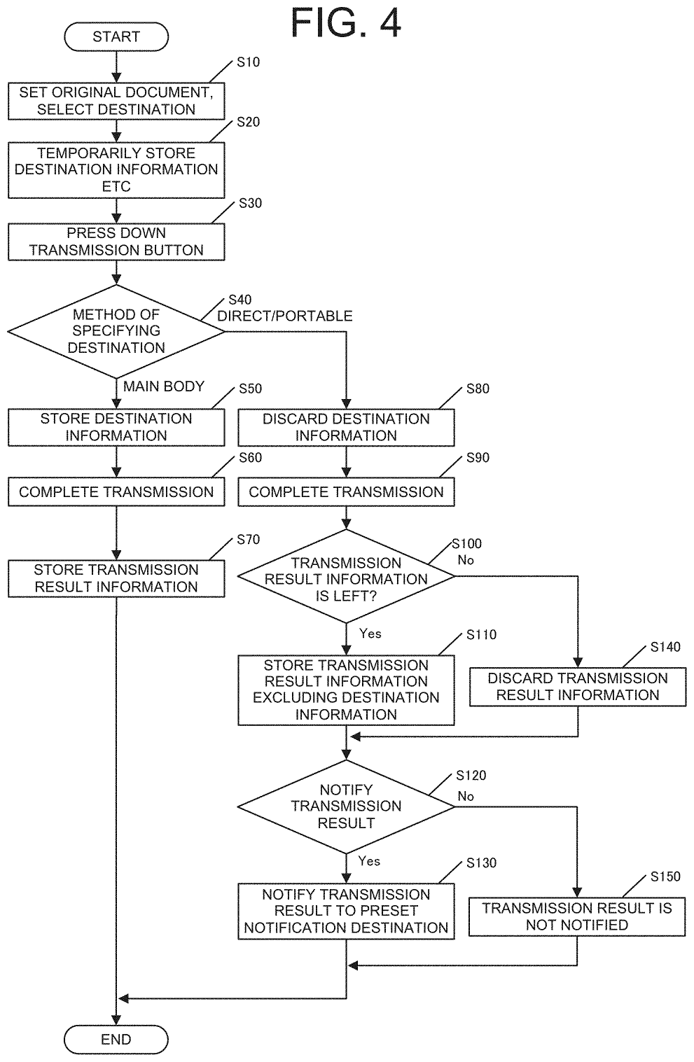

The flow of processing in the first embodiment will then be described. FIG. 4 is a flowchart for illustrating processing from the selection of a destination to the notification of the result of transmission related to the data communication of fax or electronic mail.

The user first sets the original document on the image reader 21, specifies any one of the address book managed by the main body of the device, the direct input of the destination through the inputter and the address book managed by the portable terminal device and selects the destination (step S10).

The controller 11 temporarily stores, as setting values, information (such as the destination name and the destination number) on the selected destination in the main storage region 235 (step S20). The controller 11 reads other setting values related to the data communication from the setting value storage region 236 and temporarily stores them in the main storage region 235.

When the user presses down a transmission button (step S30), the controller 11 starts a job related to data transmission based on the destination information, the setting values and the like temporarily stored in the main storage region 235.

The controller 11 determines which one of the address book managed by the main body of the device, the direct input of the destination through the inputter and the address book managed by the portable terminal device is specified (step S40).

When the method of specifying the destination is the method of specifying the address book managed by the main body of the device (step S40: main body), the controller 11 determines that the destination information is left. The controller 11 stores the destination information as the setting history information in the setting history information storage region 237 (step S50).

When the data transmission is completed (step S60), the controller 11 generates the transmission result information. The controller 11 stores the generated transmission result information as the setting history information in the setting history information storage region 237 (step S70) and completes the processing.

On the other hand, when the method of specifying the destination utilizes the direct input of the destination through the inputter or the address book managed by the portable terminal device (step S40: direct or portable), the controller 11 determines that the destination information is not left. The controller 11 discards the destination information from the main storage region 235 (step S80).

When the data transmission is completed (step S90), the controller 11 generates the transmission result information. Then, the controller 11 determines whether or not the transmission result information is left as the setting history information (step S100). The controller 11 determines, based on a setting through the setting screen made by the user or the system setting, whether or not the transmission result information is left as the setting history information.

When the controller 11 determines that the transmission result information is left as the setting history information (step S100: yes), the controller 11 stores the transmission result information excluding the destination information as the setting history information in the setting history information storage region 237 (step S110).

On the other hand, when the controller 11 determines that the transmission result information is not left as the setting history information (step S100: no), the controller 11 discards the transmission result information (step S140).

Then, the controller 11 determines whether or not the result of transmission is notified (step S120). The controller 11 determines, based on the setting through the setting screen made by the user or the system setting, whether or not the result of transmission is notified.

When the controller 11 determines that the result of transmission is notified (step S120: yes), the controller 11 notifies the result of transmission to a preset notification destination (step S130) and completes the processing.

On the other hand, when the controller 11 determines that the result of transmission is not notified (step S120: no), the controller 11 does not notify the result of transmission (step S150) and completes the processing.

### 1.3 Operation Example

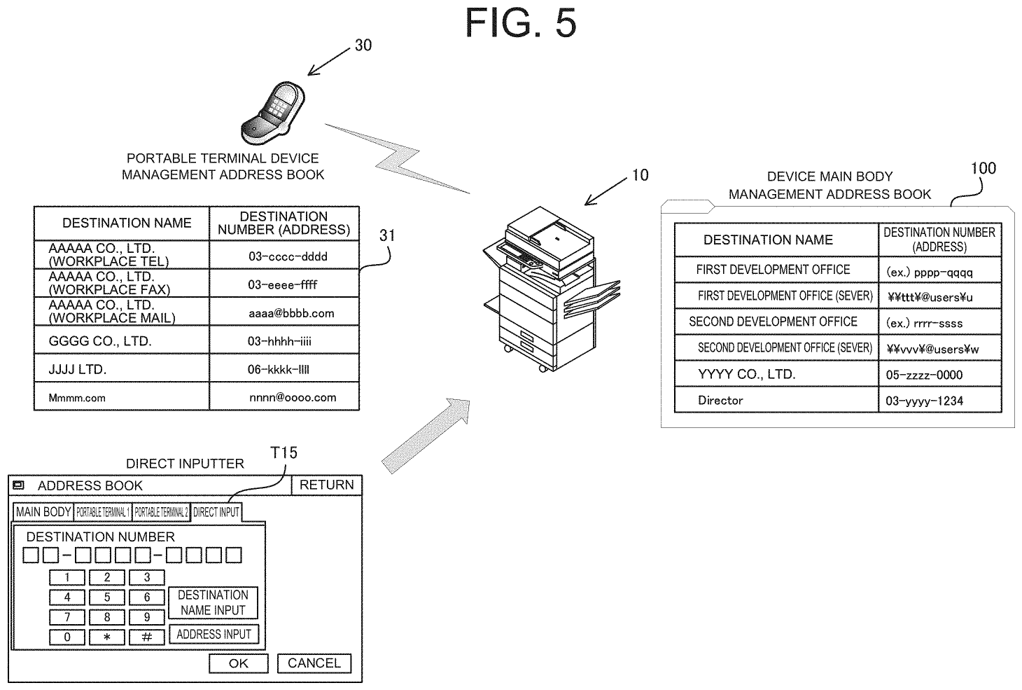

An example of an operation in the first embodiment will then be described. FIG. 5 is a diagram for illustrating an example of the configuration of the address book managed by the main body of the device, the direct input of the destination through the inputter and the address book managed by the portable terminal device in the first embodiment.

For example, the portable terminal device 30 is a portable information terminal device such as a portable phone, a smart phone, a tablet or a notebook PC (Personal computer). The portable terminal device 30 associates a specific destination name with various types of address information such as a telephone number, a fax number, an electronic mail address and an address/location, and manages the information described above as the address book 31. The portable terminal device 30 includes, for example, a wireless communication system of infrared communication, Bluetooth (registered trademark), wireless LAN (Local area network) or the like or a wired communication system, and thereby can transmit and receive data to and from the multifunctional machine 10. The multifunctional machine 10 is connected to the portable terminal device 30 to acquire the address book 31, and thereby can utilize the address book 31 of the portable terminal device 30.

FIG. 5 illustrates one form of the address book 31 in which the destination name (for example, AAAAA Co. Ltd. (workplace Mail)) is associated with the destination number (address) (for example, aaaa@bbbb.com). The user selects desired destination information from the address book 31 acquired by the multifunctional machine 10, causes the multifunctional machine 10 to execute a job related to the data communication and thereby can transmit fax data, electronic mail data or the like to the selected destination. The address book 31 illustrated in FIG. 5 is simply one form, and the configuration of the address book 31 is not limited to the form illustrated in FIG. 5.

A direct input tab T15 serving as a direct inputter is an input screen through which the multifunctional machine 10 receives the direct input of the destination information in the data communication. When the multifunctional machine 10 receives the input of the destination information through the direct input tab T15, the multifunctional machine 10 sets the destination of the data communication.

The address book 100 managed by the main body of the multifunctional machine 10 is information in which in the job related to the data communication executed by the multifunctional machine 10, the destination name is associated with the destination number (address) such as a telephone number, a fax number or an electronic mail address and which is managed as the address book 100. The controller 11 stores the address book 100 in the destination information storage region 238 of the storage 23. The address book 100 can be called up as the address book screen described later when the job related to the data communication is executed.

FIG. 5 illustrates one form of the address book 100 in which the destination name (for example, second development office (server)) is associated with the destination number (address) (for example, ¥¥vvv¥@users¥w). The user selects desired destination information from the address book 100, causes the multifunctional machine 10 to execute the job related to the data communication and thereby can transmit fax data, electronic mail data or the like. The address book 100 illustrated in FIG. 5 is simply one form, and the configuration of the address book 100 is not limited to the form illustrated in FIG. 5.

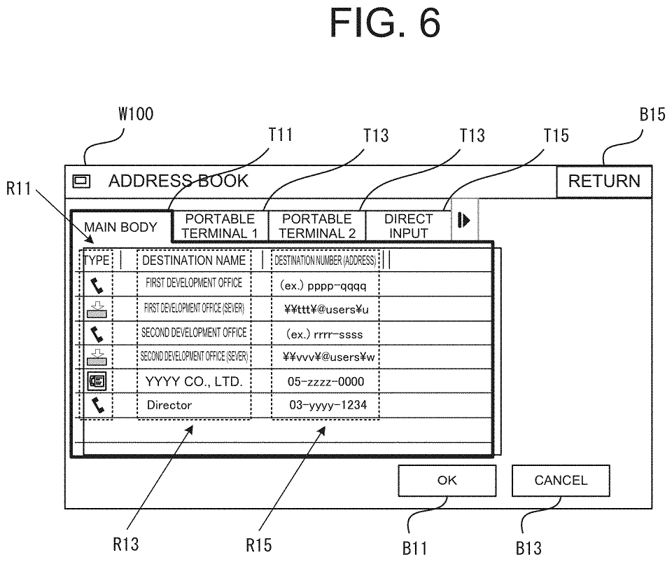

FIG. 6 is an example of the configuration of the address book screen W100 included in the multifunctional machine 10. The controller 11 displays the address book screen W100 when the selection of the destination is received in step S10 of FIG. 4. The address book screen W100 includes a main body address book tab T11, a portable terminal address book tab T13, a direct input tab T15, an OK button B11, a cancel button B13 and a return button B15. FIG. 6 is an example of the configuration when the destination is selected through the main body address book tab T11.

The main body address book tab T11 includes a job type display region R11, a destination name display region R13 and a destination number (address) display region R15. The job type display region R11 is a display region in which an image (for example, a handset mark) symbolizing the job is displayed so that the type of job can be grasped intuitively. The destination name display region R13 is a region in which the destination name is displayed. The destination number (address) display region R15 is a display region in which the destination number (address) associated with the destination name is displayed.

The user selects the destination of the data communication from destinations displayed in the destination name display region R13. For example, the controller 11 darkens the selected destination to be able to notify the user of information indicating that the destination is selected.

The OK button B11 is an input button through which the selection of the destination made by the user is received. The cancel button B13 is an input button through which the cancelation of the selection of the destination performed by the user is received. The return button B15 is an input button through which an input for closing the address book screen W100 and changing the screen to, for example, a home screen is received.

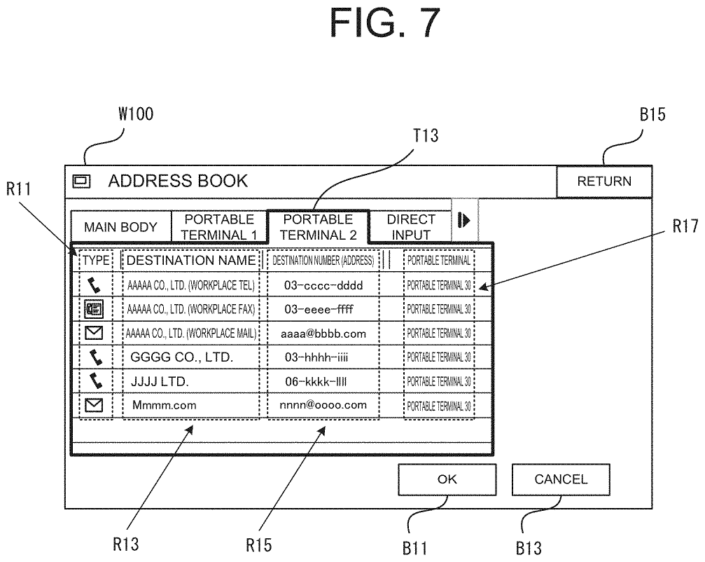

FIG. 7 is an example of the configuration when the destination is selected through the portable terminal address book tab T13. The portable terminal address book tab T13 displays the destination information acquired from the address book managed by the portable terminal device. Although the configuration of the portable terminal address book tab T13 can be the same as that of the main body address book tab T11, the portable terminal address book tab T13 differs therefrom in that the portable terminal address book tab T13 includes a portable terminal display region R17 indicating the acquisition source of the address information. The same configurations as in the main body address book tab T11 are identified with the same signs, and the description thereof will be omitted.

The portable terminal display region R17 is a display region in which the device name of the portable terminal device 30 (see FIG. 5) serving as the acquisition source of the destination information is displayed.

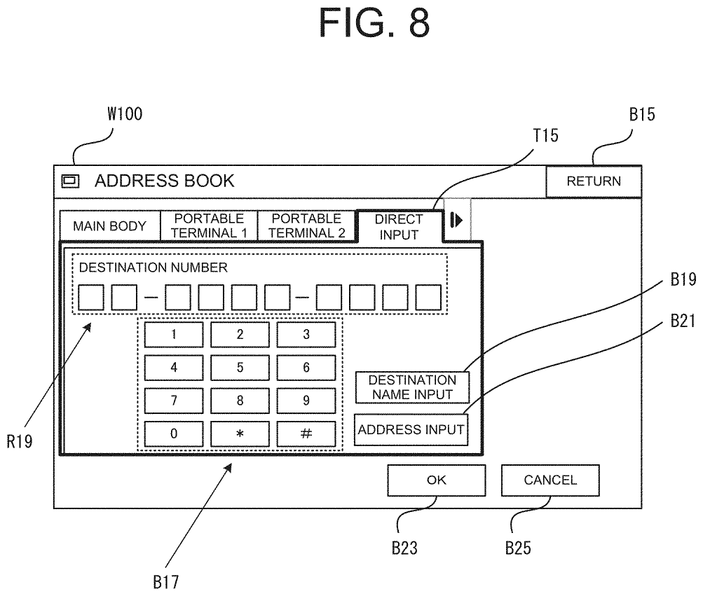

FIG. 8 is an example of the configuration when the destination is directly input through the direct input tab T15. The direct input tab T15 includes a destination number display region R19, a destination number input button B17, a destination name input button B19, an address input button B21, an OK button B23 and a cancel button B25.

The destination number display region R19 displays the result of an input produced with the destination number input button B17. FIG. 8 is one form of the direct input of the destination number related to the transmission of fax serving as the job related to the data communication. The user inputs the destination number of fax data through the destination number input button B17. The destination number which is input is displayed in the destination number display region R19.

The destination name input button B19 receives the input of the destination name corresponding to the destination number input through the destination number input button B17. When the user presses down the destination name input button B19, the screen is changed to an unillustrated name input screen. The user can input the destination name through the name input screen.

The address input button B21 receives the input of the address of electronic mail when the job related to the data communication is the transmission of electronic mail. When the address input button B21 is pressed down, the screen is changed to an unillustrated address input screen. The user can input the address of electronic mail through the address input screen.

The OK button B23 is an input button through which the determination of the input of the destination number made by the user is received. The cancel button B25 is an input button through which the cancelation of the input of the destination number performed by the user is received.

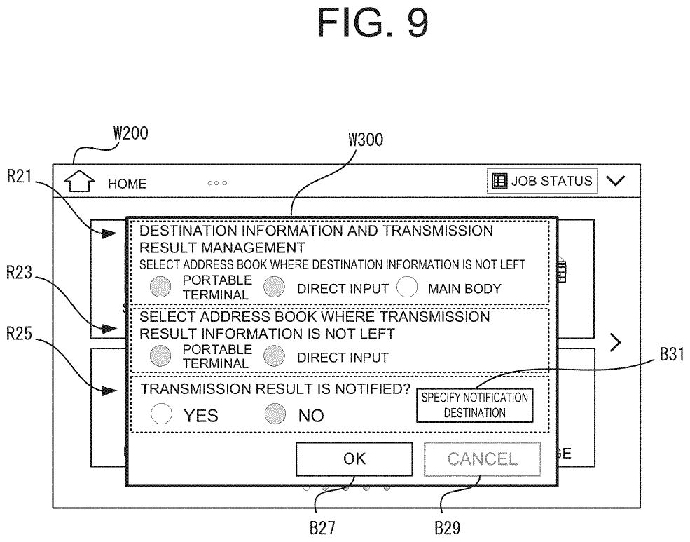

FIG. 9 is an example of the configuration of a destination information and transmission result management screen W300. The destination information and transmission result management screen W300 includes a first address book selection region R21 in which the selection of an address book where the destination information is not to be left after the execution of a job is received, a second address book selection region R23 in which the selection of an address book where the transmission result information is not to be left is received, a transmission result notification selection region R25 in which a selection as to whether or not the result of transmission is notified is received, an OK button B27, a cancel button B29 and a notification destination specifying button B31.

The first address book selection region R21 is a selection region in which the selection of the address book where the destination information is not to be left is received. In the first embodiment, as the address book capable of being selected, any one of the address book managed by the portable terminal device, the direct input of the destination through the inputter and the address book managed by the main body of the device is a target. The user selects the address book where the destination information is not to be left. FIG. 9 is an example in which, as the address books where the destination information is not to be left, the address book managed by the portable terminal device and the direct input of the destination through the inputter are selected.

The result of the selection in the first address book selection region R21 is referenced by the controller 11 in step S40 of FIG. 4. The controller 11 determines, based on the result of the reference, whether or not the destination information is left.

FIG. 9 illustrates that, as the address books where the destination information is not to be left, the address book managed by the portable terminal device and the direct input of the destination through the inputter are selected. When the method of specifying the destination utilizes the direct input of the destination through the inputter or the address book managed by the portable terminal device, the controller 11 determines, based on the result of the selection made by the user, that the destination information is not left. Consequently, the destination information is discarded in step S80 of FIG. 4, and the destination information is not stored as the setting history information.

The second address book selection region R23 is a selection region in which the selection of the address book where the transmission result information is not to be left is received. In the first address book selection region R21, as the address books where the destination information is not to be left, the address book managed by the portable terminal device and the direct input of the destination through the inputter are selected. Hence, as the targets of the address book where the transmission result information is not to be left, the address book managed by the portable terminal device and the direct input of the destination through the inputter are displayed. The user selects one or both of the displayed targets to be able to select the address book where the transmission result information is not to be left.

The result of the selection in the second address book selection region R23 is referenced by the controller 11 in step S100 of FIG. 4. The controller 11 determines, based on the result of the reference, whether or not the transmission result information is stored.

FIG. 9 illustrates that, as the address books where the transmission result information is not to be left, both the address book managed by the portable terminal device and the direct input of the destination through the inputter are selected. The controller 11 determines, based on the result of the selection made by the user, that the transmission result information is discarded. Since the transmission result information is discarded, the transmission result information is not stored as the setting history information.

The transmission result notification selection region R25 is a selection region in which a selection as to whether or not the result of transmission is notified to a predetermined notification destination is received. When the result of transmission is desired to be notified, the user selects a “yes” button. On the other hand, when the result of transmission is not notified, the user selects a “no” button. The transmission result notification selection region R25 includes the notification destination specifying button B31. When the user presses down the notification destination specifying button B31, an unillustrated notification destination setting screen is displayed. The user can specify the notification destination to which the result of transmission is notified through the unillustrated notification destination setting screen.

The result of the selection in the transmission result notification selection region R25 is referenced by the controller 11 in step S120 of FIG. 4. The controller 11 determines, based on the result of the reference, whether or not the result of transmission is notified.

The OK button B27 is an input button through which the determination of the selection made by the user is received. The cancel button B29 is an input button through which the cancelation of the selection performed by the user is received.

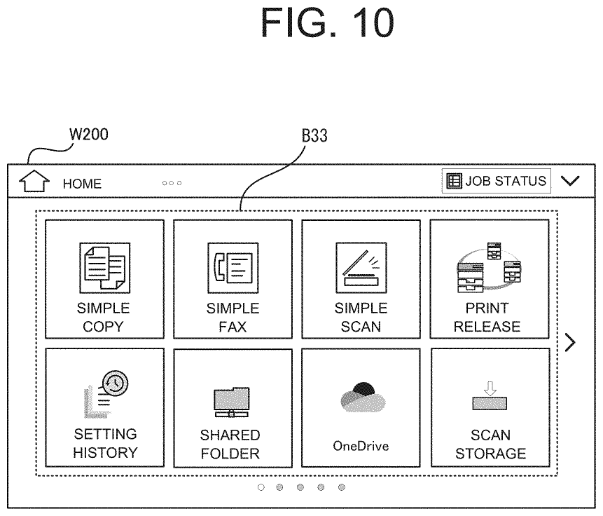

For example, the destination information and transmission result management screen W300 can be started up by pressing down the input buttons of job functions and the like B33 for receiving the selection of a job function such as simple fax or simple scan on a common screen W200 illustrated in FIG. 10. A start-up timing with which the destination information and transmission result management screen W300 is started up is not limited to the timing described above as long as the start-up timing is a timing with which a selection on the destination information and the transmission result information can be received before the execution of a job based on each function.

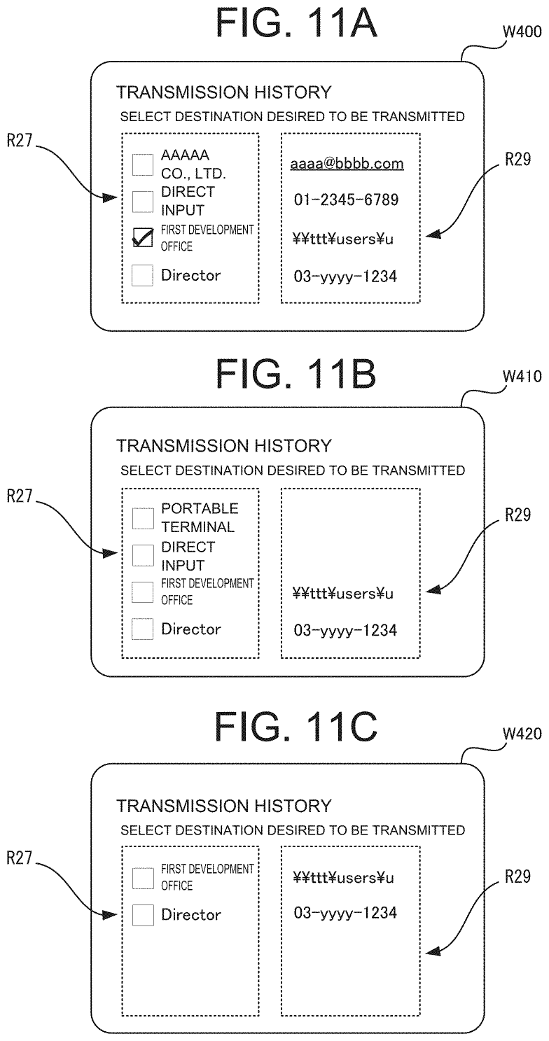

FIGS. 11A, 11B and 11C are an example of the configuration of the transmission history related to the data communication. The transmission history is a history screen which is referenced by the user or the like who wants to execute a job related to the data communication. The user makes a selection from destinations related to executed jobs which are displayed, and thereby can set the destination of the data communication.

The transmission history in the first embodiment can be generated using the setting history information related to the data communication. As illustrated in FIG. 3, the setting history information includes, as setting values, the destination information including the destination number and the destination name and the transmission result information. Transmission history screens W400 to W420 illustrated in FIGS. 11A, 11B and 11C include a destination name region R27 in which destination names acquired from the setting history information are displayed and a destination number region R29 in which destination numbers are displayed.

The user checks the destination names displayed in the destination name region R27 and the destination numbers displayed in the destination number region R29, checks a check box provided on the left side of the destination name and thereby can set the destination of the data communication.

Here, FIG. 11A is an example of the display configuration of the transmission history screen W400 when the address book where the destination information is not to be left after the execution of a job is not selected through the destination information and transmission result management screen W300. In this case, regardless of the address book managed by the portable terminal device and the direct input of the destination through the inputter, the destination information (the destination names and the destination numbers) stored as the setting history information is displayed.

FIG. 11B is an example of the display configuration of the transmission history screen W410 when in the first address book selection region R21 on the destination information and transmission result management screen W300, as the address books where the destination information is not to be left after the execution of a job, the address book managed by the portable terminal device and the direct input of the destination through the inputter are selected. In this case, the destinations selected and input with the address book managed by the portable terminal device and the direct input of the destination through the inputter are not stored as the setting history information. Hence, on the transmission history screen W410, only the acquisition source information (management source) of the destination information is displayed as the result of transmission, and the destination name and the destination number are not displayed.

FIG. 11C is an example of the display configuration of the transmission history screen W420 when in the first address book selection region R21 and the second address book selection region R23 on the destination information and transmission result management screen W300, as the address books where the destination information and the transmission result information are not to be left after the execution of a job, the address book managed by the portable terminal device and the direct input of the destination through the inputter are selected. In this case, the destinations selected and input with the address book managed by the portable terminal device and the direct input of the destination through the inputter are not stored as the setting history information. Likewise, the transmission result information related to the data communication is not stored as the setting history information. Hence, on the transmission history screen W420, the result of transmission of the job executed based on the destinations selected and input with the address book managed by the portable terminal device and the direct input of the destination through the inputter is not displayed.

As described above, in the first embodiment, for destinations acquired from specific address book acquisition sources, a selection as to whether or not the destination information and the transmission result information are left can be made, with the result that it is possible to ensure privacy and enhance security in the display of the destination information and the result of transmission.

### 2. Second Embodiment

In the description of the first embodiment, as the specific address book acquisition sources, the address book managed by the portable terminal device and the direct input of the destination through the inputter are targets. A description will be given of a second embodiment in which processing for determining whether or not the destination information is left is also performed on destinations included in the address book managed by the main body of the device.

2.1 Functional Configuration

The functional configuration of a multifunctional machine according to the second embodiment can be the same as the functional configuration of the multifunctional machine 10 according to the first embodiment. Hence, the description of the functional configuration in the second embodiment will be omitted.

2.2 Flow of Processing

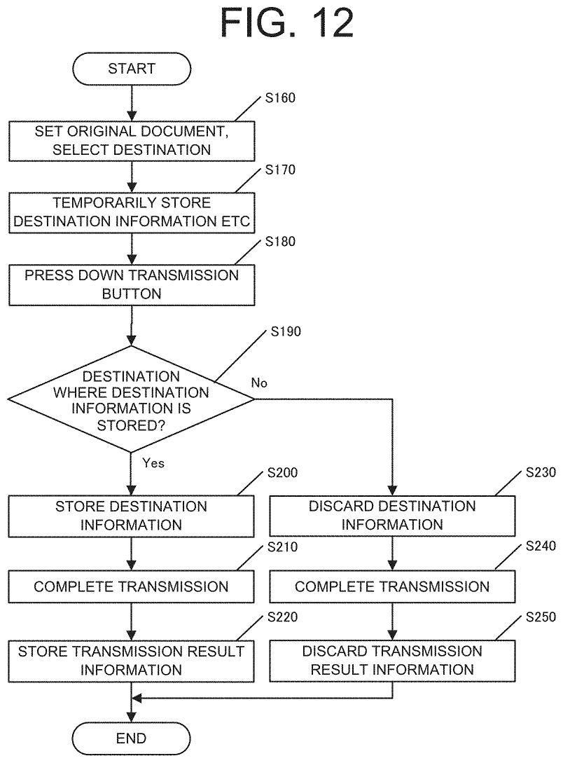

The flow of processing in the second embodiment will be described with reference to the flowchart of FIG. 12. FIG. 12 is the flowchart for illustrating processing from the selection of the destination related to the data communication of fax or electronic mail to the storage of the transmission result information.

The user first sets the original document on the image reader 21, and selects the destination included in the address book managed by the main body of the device (step S160).

The controller 11 temporarily stores, as setting values, information on the selected destination in the main storage region 235 (step S170). The controller 11 reads other setting values related to the data communication from the setting value storage region 236 and temporarily stores them in the main storage region 235.

When the user presses down the transmission button (step S180), the controller 11 starts a job related to the data transmission based on the destination information, the setting values and the like temporarily stored in the main storage region 235.

The controller 11 determines whether the destination information on the selected destination is information which is left as the setting history information (step S190).

When the destination information on the selected destination is information which is left as the setting history information (step S190: yes), the controller 11 stores the destination information as the setting history information in the setting history information storage region 237 (step S200).

When the data transmission is completed (step S210), the controller 11 generates the transmission result information. Then, the controller 11 stores the transmission result information as the setting history information in the setting history information storage region 237 (step S220) and completes the processing.

On the other hand, when the destination information on the selected destination is not information which is left as the setting history information (step S190: no), the controller 11 discards the destination information from the main storage region 235 (step S230).

When the data transmission is completed (step S240), the controller 11 generates the transmission result information. However, the controller 11 discards the transmission result information (step S250) and completes the processing.

### 2.3 Operation Example

An example of an operation in the second embodiment will then be described. In the second embodiment, the user can select, as in the first embodiment, the destination using the main body address book tab T11 on the address book screen W100. Hence, the description of an example of the operation related to the selection of the destination will be omitted.

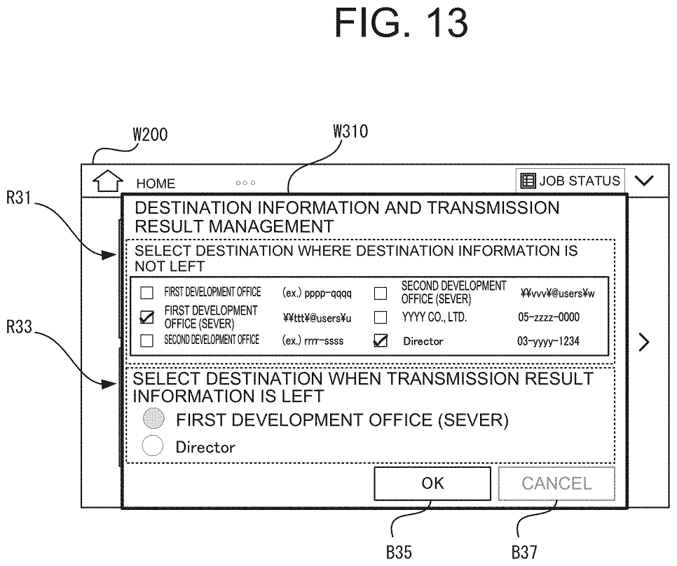

FIG. 13 is an example of the configuration of a destination information and transmission result management screen W310. The destination information and transmission result management screen W310 includes a first destination selection region R31 in which the selection of a destination where the destination information is not to be left after the execution of a job is received, a second destination selection region R33 in which the selection of a destination where the transmission result information is to be left is received, an OK button B35 and a cancel button B37.

The first destination selection region R31 is a selection region in which the selection of the destination where the destination information is not to be left is received. In the second embodiment, as the destination capable of being selected, the address book managed by the main body of the device is a target. The user selects the destination where the destination information is not to be left. FIG. 13 is an example in which, as the destinations where the destination information is not to be left, a destination name: first development office (server) with a destination number (address): ¥¥ttt¥@users¥u and a destination name: Director with a destination number (address): 03-yyyy-1234 are selected.

The result of the selection in the first destination selection region R31 is referenced by the controller 11 in step S190 of FIG. 12. The controller 11 determines, based on the result of the reference, whether or not the destination information is left.

FIG. 13 illustrates that, as the destinations where the destination information is not to be left, the destination name: first development office (server) and the destination name: Director are selected. Based on the result of the selection made by the user, the controller 11 determines, for the destinations, that the destination information is not left. Consequently, in step S230 of FIG. 12, the destination information is discarded, and the destination information is not stored as the setting history information.

The transmission result information related to the destinations selected in the first destination selection region R31 is basically discarded (step S250 of FIG. 12). However, when the transmission result information is desired to be left, in the second destination selection region R33, the destination is selected, and thus the transmission result information can be left.

FIG. 13 illustrates that, as the destination where the transmission result information is to be left, the destination name: first development office (server) is selected. The controller 11 determines, based on the result of the selection made by the user, that the transmission result information is left. Consequently, the transmission result information is stored as the setting history information.

The OK button B35 is an input button through which the determination of the selection made by the user is received. The cancel button B37 is an input button through which the cancelation of the selection performed by the user is received.

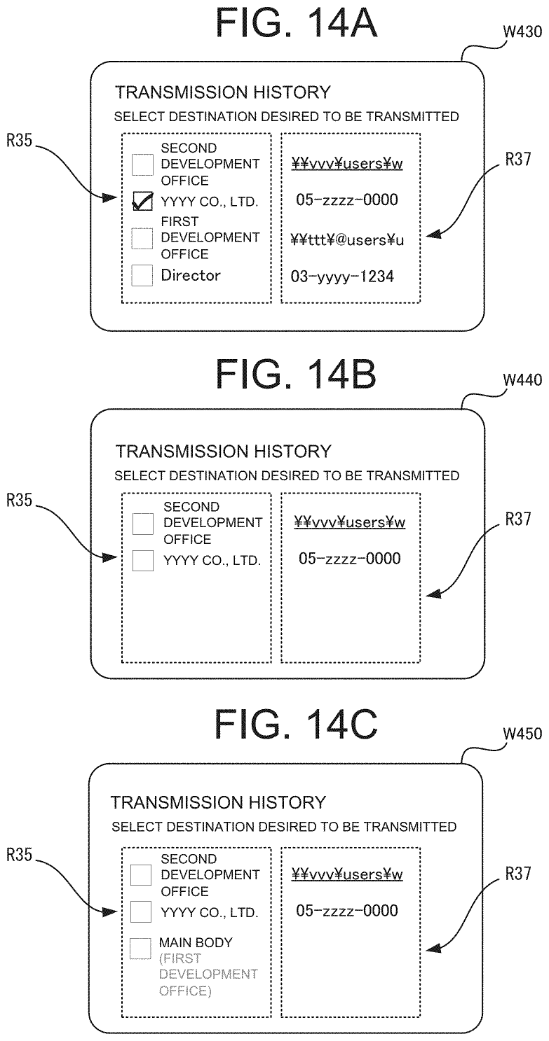

FIGS. 14A, 14B and 14C are an example of the configuration of the transmission history related to the data communication. As in the first embodiment, the transmission history in the second embodiment can be generated using the setting history information related to the data communication. Transmission history screens W430 to W450 illustrated in FIGS. 14A, 14B and 14C include a destination name region R35 in which destination names acquired from the setting history information are displayed and a destination number region R37 in which destination numbers are displayed.

The user checks the destination names displayed in the destination name region R35 and the destination numbers displayed in the destination number region R37, checks a check box provided on the left side of the destination name and thereby can set the destination of the data communication.

Here, FIG. 14A is an example of the display configuration of the transmission history screen W430 when the destination where the destination information is not to be left after the execution of a job is not selected through the destination information and transmission result management screen W310. In this case, the destination information (the destination names and the destination numbers) stored as the setting history information is displayed.

FIG. 14B is an example of the display configuration of the transmission history screen W440 when in the first address book selection region R31 on the destination information and transmission result management screen W310, as the destinations where the destination information is not to be left after the execution of a job, the destination name: first development office (server) with the destination number (address): ¥¥ttt¥@users¥u and the destination name: Director with the destination number (address): 03-yyyy-1234 are selected. In this case, the destination information related to the destination name: first development office (server) and the destination name: Director is not stored as the setting history information. Likewise, the transmission result information related to the data communication is not stored as the setting history information. Hence, on the transmission history screen W440, the result of transmission of the job executed based on the destinations related to the destination name: first development office (server) and the destination name: Director is not displayed.

FIG. 14C is an example of the display configuration of the transmission history screen W450 when in the second destination selection region R33 on the destination information and transmission result management screen W310, as the destinations where the transmission result information is to be left after the execution of a job, the destination name: first development office (server) is selected. In this case, the destination information related to the destination name: first development office (server) is not stored as the setting history information. However, the transmission result information related to the data communication is stored as the setting history information. Hence, on the transmission history screen W450, the result of transmission of the job executed based on the destination information related to the destination name: first development office (server) is displayed as the “main body”, with the result that the user can grasp the result of transmission of the job.

As described above, in the second embodiment, for destinations included in the address book managed by the main body of the device, a selection as to whether or not the destination information and the transmission result information are left can be made, with the result that as in the first embodiment, it is possible to ensure privacy and enhance security in the display of the destination information and the result of transmission.

### 3. Third Embodiment

A description will be given of a third embodiment in which processing for determining whether or not the destination information is left is performed regardless of the address book acquisition source.

3.1 Functional Configuration

The functional configuration of a multifunctional machine according to the third embodiment can be the same as the functional configuration of the multifunctional machine 10 according to the first embodiment. Hence, the description of the functional configuration in the third embodiment will be omitted.

3.2 Flow of Processing

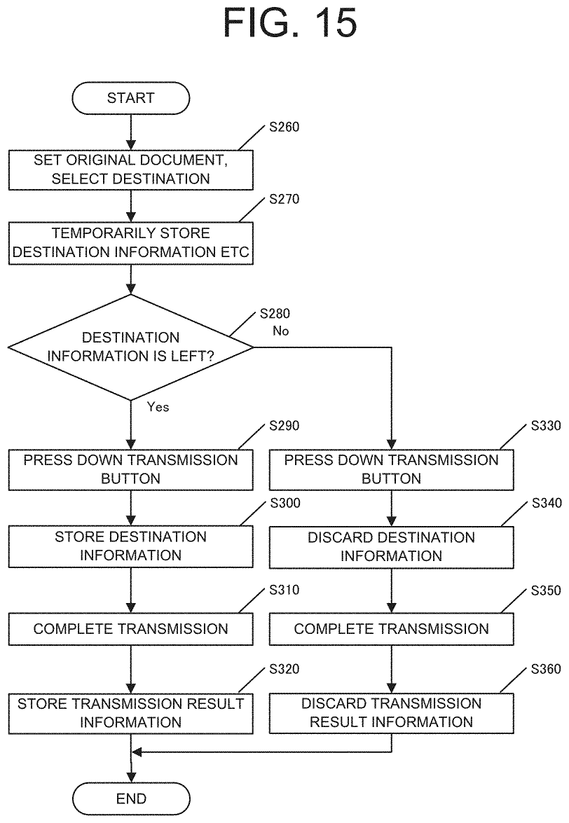

The flow of processing in the third embodiment will be described with reference to the flowchart of FIG. 15. FIG. 15 is the flowchart for illustrating processing from the selection of the destination related to the data communication of fax or electronic mail to the storage of the transmission result information.

The user first sets the original document on the image reader 21, specifies any one of the address book managed by the main body of the device, the direct input of the destination through the inputter and the address book managed by the portable terminal device and selects the destination (step S260).

The controller 11 temporarily stores, as setting values, information on the selected destination in the main storage region 235 (step S270). The controller 11 reads other setting values related to the data communication from the setting value storage region 236 and temporarily stores them in the main storage region 235.

The controller 11 determines whether or not the destination information on the selected destination is left (step S280). In a case where the destination information is left (step S280: yes), when the user presses down the transmission button (step S290), the controller 11 starts a job related to the data transmission based on the destination information, the setting values and the like temporarily stored in the main storage region 235.

The controller 11 stores the destination information as the setting history information in the setting history information storage region 237 (step S300).

When the data transmission is completed (step S310), the controller 11 generates the transmission result information. Then, the controller 11 stores the transmission result information as the setting history information in the setting history information storage region 237 (step S320) and completes the processing.

On the other hand, in a case where the destination information is not left (step S280: no), when the user presses down the transmission button (step S330), the controller 11 starts a job related to the data transmission based on the destination information, the setting values and the like temporarily stored in the main storage region 235.

Then, the controller 11 discards the destination information from the main storage region 235 (step S340).

When the data transmission is completed (step S350), the controller 11 generates the transmission result information. However, the controller 11 discards the transmission result information (step S360) and completes the processing.

3.3 Operation Example

An example of an operation in the third embodiment will then be described. In the third embodiment, the user can select, as in the first embodiment, the destination using the main body address book tab T11, the portable terminal address book tab T13 or the direct input tab T15 on the address book screen W100. Hence, the description of an example of the operation related to the selection of the destination will be omitted.

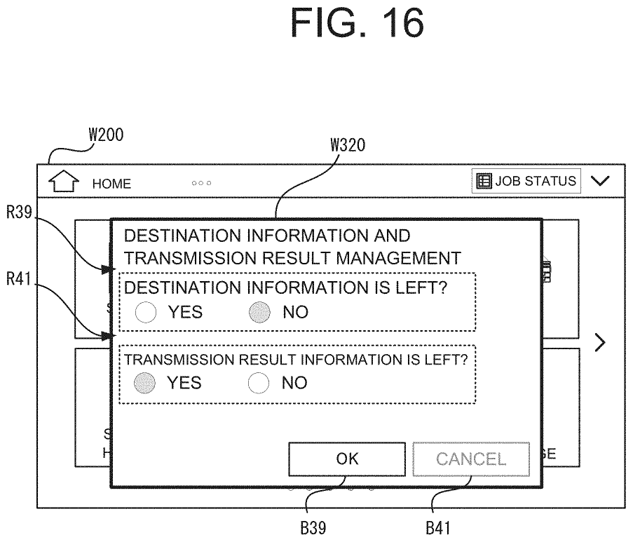

FIG. 16 is an example of the configuration of a destination information and transmission result management screen W320. The destination information and transmission result management screen W320 includes a first selection region R39 in which a selection as to whether or not the destination information is left after the execution of a job is received, a second selection region R41 in which a selection as to whether or not the transmission result information is left is received, an OK button B39 and a cancel button B41.

The first selection region R39 is a selection region in which a selection as to whether or not the destination information is left is received. In the third embodiment, the targets of the destination information are all the destination information related to the address book managed by the main body of the device, the destination information related to the address book managed by the portable terminal device and the direct input of the destination through the inputter. The user selects whether or not the destination information is left. FIG. 16 is an example in which “no” indicating that the destination information is not left is selected.

The result of the selection in the first selection region R39 is referenced by the controller 11 in step S280 of FIG. 15. The controller 11 determines, based on the result of the reference, whether or not the destination information is left.

FIG. 16 illustrates that “no” indicating that the destination information is not left is selected. The controller 11 determines, based on the result of the selection made by the user, that the destination information is not left. Consequently, in step S340 of FIG. 15, the destination information is discarded, and the destination information is not stored as the setting history information.

When “no” indicating that the destination information is not left is selected in the first selection region R39, the transmission result information related to the destination information is basically discarded (step S360 of FIG. 15). However, when the transmission result information is desired to be left, in the second selection region R41, “yes” indicating that the transmission result information is left is selected, and thus the transmission result information can be left.

FIG. 16 illustrates that “yes” indicating that the transmission result information is left is selected. The controller 11 determines, based on the result of the selection made by the user, that the transmission result information is left. Consequently, the transmission result information is stored as the setting history information.

The OK button B39 is an input button through which the determination of the selection made by the user is received. The cancel button B41 is an input button through which the cancelation of the selection performed by the user is received.

As described above, in the third embodiment, regardless of the address book acquisition source, a selection as to whether or not the destination information and the transmission result information are left can be made, with the result that as in the first embodiment, it is possible to ensure privacy and enhance security in the display of the destination information and the result of transmission.

The present invention is not limited to the embodiments described above, and various modifications are possible. Specifically, embodiments obtained by combining technical methods resulting from appropriate changes without departing from the spirit of the present invention are also included in the technical scope of the present invention. For example, when in a so-called broadcast transmission job for transmitting data to a plurality of destinations, destinations where the destination information is to be left and the destinations where the destination information is not to be left are present in a mixed manner, the setting history information is left only for the destination information set such that the destination information is left whereas when in the setting screen or the system setting, at least one destination set such that the destination information is not left for a plurality of destinations is included or when a setting is made such that all the destination information is not left as the setting history information, all the destination information may be discarded according to the setting described above.

Although for convenience of description, the above-mentioned embodiments are described individually and separately, it is needless to say that they may be combined in a technically feasible range to be performed.

Programs which are operated by the individual devices in the embodiments are programs (programs which instruct a computer to function) which control a CPU and the like so as to realize the functions in the embodiments described above. The information handled in these devices is temporarily stored in a temporary storage device (for example, a RAM) when the information is processed, is then stored in various storage devices such as a ROM (Read Only Memory) and an HDD and is read, modified and written by the CPU as necessary.

Here, a recording medium for storing the programs may be any of a semiconductor medium (such as a ROM or a nonvolatile memory card), an optical recording medium/optical magnetic recording medium (such as a DVD (Digital Versatile Disc), an MO (Magneto Optical Disc), an MD (Mini Disc), a CD (Compact Disc), a BD (Blu-ray Disk (registered trademark), a magnetic recording medium (such as a magnetic tape or a flexible disc) and the like. The programs which are loaded are executed, and thus the functions in the embodiments described above are realized, and moreover, it is likely that based on the instructions of the programs, processing is performed in cooperation with an operating system, another application program or the like to realize the functions in the present invention.

When the programs are distributed to the market, the programs can be stored in a portable recording medium to be distributed or can be transferred to a server computer which is connected through a network such as the Internet. In this case, a storage device in the server computer is naturally included in the present invention.

What is claimed is:

1. An information processing device comprising:
a controller that executes a job; and
a storage that stores, as setting history information, a setting value related to the execution of the job,
wherein the controller executes, after the execution of the job, determination processing on the setting value and reflects a result of determination to store the setting history information.

2. The information processing device according to claim 1,
wherein the job is a job related to data communication, and
the controller determines whether or not destination information in the data communication serving as the setting value is stored as the setting history information.

3. The information processing device according to claim 2,
wherein when the controller determines that the destination information in the data communication serving as the setting value is not stored as the setting history information, the controller discards the destination information.

4. The information processing device according to claim 2,
wherein when the destination information is acquired from outside, the controller executes the determination processing.

5. The information processing device according to claim 3,
wherein when the destination information is acquired from outside, the controller executes the determination processing.

6. The information processing device according to claim 2,
wherein when the destination information is acquired from a main body of the device, the controller executes the determination processing.

7. The information processing device according to claim 3,
wherein when the destination information is acquired from a main body of the device, the controller executes the determination processing.

8. The information processing device according to claim 2,
wherein the controller determines whether or not a result of transmission related to the data communication and serving as the setting value is stored as the setting history information.

9. The information processing device according to claim 3,
wherein the controller determines whether or not a result of transmission related to the data communication and serving as the setting value is stored as the setting history information.

10. The information processing device according to claim 4,
wherein the controller determines whether or not a result of transmission related to the data communication and serving as the setting value is stored as the setting history information.

11. The information processing device according to claim 5,
wherein the controller determines whether or not a result of transmission related to the data communication and serving as the setting value is stored as the setting history information.

12. The information processing device according to claim 6,
wherein the controller determines whether or not a result of transmission related to the data communication and serving as the setting value is stored as the setting history information.

13. The information processing device according to claim 7,
wherein the controller determines whether or not a result of transmission related to the data communication and serving as the setting value is stored as the setting history information.

14. The information processing device according to claim 4,
wherein the destination information acquired from outside is the destination information that is stored in a portable terminal device or the destination information that is input directly.

15. The information processing device according to claim 5,
wherein the destination information acquired from outside is the destination information that is stored in a portable terminal device or the destination information that is input directly.

16. The information processing device according to claim 1, further comprising:
a display that selects the setting value included in the setting history information and displays history information related to the selected setting value.

17. The information processing device according to claim 2, further comprising:
a display that selects the setting value included in the setting history information and displays history information related to the selected setting value.

18. The information processing device according to claim 3, further comprising:
a display that selects the setting value included in the setting history information and displays history information related to the selected setting value.

19. An information processing method comprising:
executing a job; and
storing, as setting history information, a setting value related to the execution of the job,
wherein the execution of the job includes executing, after the execution of the job, determination processing on the setting value and reflecting a result of determination to store the setting history information.
